(19) United States
(12) Patent Application Publication
(10) Pub. No.: US 2026/0002094 A1
(43) Pub. Date: Jan. 1, 2026

(54) SOLID WAREWASH DETERGENT COMPOSITION USING ANHYDROUS SODIUM SULFATE TO IMPROVE STABILITY

(71) Applicant: ECOLAB USA INC., Saint Paul, MN (US)

(72) Inventors: Michael S. Rischmiller, Eagan, MN (US); John Mansergh, Cottage Grove, MN (US)

(21) Appl. No.: 19/235,844

(22) Filed: Jun. 12, 2025

Related U.S. Application Data
(60) Provisional application No. 63/664,795, filed on Jun. 27, 2024.

(51) Int. Cl. C11D 3/04; C11D 3/22; C11D 3/33; C11D 17/00

(52) U.S. Cl. CPC C11D 3/044; C11D 3/046; C11D 3/221; C11D 3/33; C11D 17/0052

(57) ABSTRACT

Methods and compositions for forming stable cast solids are provided. Methods and compositions that incorporate a water scavenger compete for available water to provide stable cast solids with a high content of granular raw materials. In particular methods of processing cast compositions to ensure non-cracked solids post chilling are provided and methods of use thereof.

### CROSS REFERENCE TO RELATED APPLICATIONS

This application claims priority under 35 U.S.C. § 119 to provisional patent application U.S. Ser. No. 63/664,795 filed Jun. 27, 2024. The provisional patent application is herein incorporated by reference in its entirety.

### TECHNICAL FIELD

The disclosure relates generally to methods and compositions for forming stable cast solids. More particularly, but not exclusively, the present disclosure relates to methods of forming stable caustic cast solid compositions with the incorporation of a water scavenger to stabilize the compositions that contain higher concentrations of granular raw materials and lower concentrations of total alkalinity (or caustic) during the cast processing to ensure non-cracked solids post chilling step of the production of the cast solid.

### BACKGROUND

Cast solids are commonly used in making solid block compositions, such as solid detergent compositions. For caustic cast solids, in many exemplary embodiments a substantial portion of an alkali metal hydroxide, most often sodium hydroxide (i.e. caustic), are cast and solidified. This process involves mixing the active components of the detergent with molten sodium hydroxide monohydrate (or molten caustic at higher temperatures) and thereafter cooling the composition to solidify. The resultant solid is a matrix of the solid sodium hydroxide with the additional ingredients that are either dissolved or suspended therein. Cast solids can incorporate an extensive number of actives into the composition. Casting can also be used for other solids in addition to caustic cast solids, such as other hydroxides, alkoxides, carbonates, PEG, and combinations thereof.

The manufacturing of cast solids, such as caustic-based cast solids often incorporate a high level of functional granular raw materials having various hydration states that present processing challenges during its manufacture. It is common to see cast solids with poor post-cooling solid integrity and uniformity resulting in undesirable appearances and uniformity of the cast solids. Thus, there exists a need in the art for methods of improving cast solid integrity.

It is therefore an object of this disclosure to provide methods of forming stable cast solid compositions that do not crack past chilling step in the cast solid manufacture.

It is another object of this disclosure to formulate stable cast solid compositions.

It is yet another object of this disclosure to formulate stable cast solid compositions providing efficacious cleaning and performance compared to higher alkalinity/caustic-containing compositions. It is to be understood that providing cast solids with higher granular raw materials content, such as chelants, the lower alkalinity/caustic concentration in the cast solid can provide various labor, performance and asset protection benefits. Other objects, embodiments and advantages of this disclosure will be apparent to one skilled in the art in view of the following disclosure, the drawings, and the appended claims.

### SUMMARY

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part. It is a primary object, feature, and/or advantage of the present disclosure to improve on or overcome the deficiencies in the art with respect to manufacturing cast solids without solid integrity, namely post-chilling in the manufacturing process.

It is a further object, feature, and/or advantage of the present disclosure to provide stable solid cast compositions that do not crack post chilling and instead maintain solid integrity with the incorporation of a water scavenger such as anhydrous sodium sulfate in the compositions and methods of making the compositions.

According to some aspects of the present disclosure, cast solid compositions comprise: a concentrated caustic source (e.g. alkali metal hydroxide monohydrate and/or alkali metal alkoxide); one or more granular raw materials, and a water scavenger comprising an alkali metal sulfate, wherein the composition is a cast solid and has an overall caustic to water weight ratio of 60/40 to 80/20, and the water scavenger aids in stabilizing the granular raw materials during the cast processing, resulting in non-cracked post chilling solid integrity.

According to additional aspects of the present disclosure, methods of forming stable cast solid compositions comprise: combining a molten concentrated caustic source, preferably sodium hydroxide monohydrate and a water scavenger to form a solution; and thereafter adding one or more granular raw materials to disperse or dissolve within the solution, wherein the composition is a cast solid and has an overall caustic to water ratio of about 60/40 to about 80/20 if the caustic source is present, and does not crack during post chilling of the cast solid.

According to still further aspects of the present disclosure, methods of using the cast solids to generate a use solution and contact an article or surface in need of claiming are provided.

While multiple embodiments are disclosed, still other embodiments will become apparent to those skilled in the art from the following detailed description, which shows and describes illustrative embodiments. Accordingly, the drawings and detailed description are to be regarded as illustrative in nature and not restrictive.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows a batch of formula A3-2 with no Sulfate after 48 hours of time. The product's appearance was described as: lots of bubbles, large cracks, and voids in capsule. The capsule appeared crushed.

FIG. 2 shows formulas F11-G1, G11-G2, and G11-G3 with 2-7.5% Gluconate after 24 hours of time. After 24 hours, F11-G1, G11-G2, and G11-G3 (2, 4, and 7.5% Gluconate respectively) all had small voids and cell-like convection structures throughout which were mostly visible on the G11-G3 (7% Gluconate).

FIG. 3 shows formulas H10, H11, and H12 with 1-5% sulfate after 24 hours of time. While a crust was observed on the surface of H11, all three formulas showed no cracks or voids.

FIG. 4 shows formula H16 with 1% sulfate, alternate polymers and no water after 24 hours of time. No cracks, voids, or convection cells were observed.

FIG. 5 shows formula F14 with 1% sulfate and 4% extra water after 24 hours of time. Deep cracks were observed.

FIG. 6 shows formula 2-1 without water contamination and with 3% water contamination after 72 hours of time. No cracking in either with some small craters and amber chunks visible.

Various embodiments of the present disclosure will be described in detail with reference to the drawings, wherein like reference numerals represent like parts throughout the several views. Reference to various embodiments does not limit the scope of the disclosure. Figures represented herein are not limitations to the various embodiments according to the disclosure and are presented for exemplary illustration of the invention. An artisan of ordinary skill in the art need not view, within isolated figure(s), the near infinite number of distinct permutations of features described in the following detailed description to facilitate an understanding of the present invention.

### DETAILED DESCRIPTION

The present disclosure is not to be limited to that described herein, which can vary and are understood by skilled artisans. No features shown or described are essential to permit basic operation of the present disclosure unless otherwise indicated. It has been found that incorporating a water scavenger, such as sodium sulfate. into cast solid compositions that employ one or more functional granular raw materials provides solid integrity of the cast composition post-chilling in the manufacturing process.

It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range.

All publications, including all patents, patent applications and other patent and non-patent publications cited or mentioned herein are incorporated herein by reference for at least the purposes that they are cited; including for example, for the disclosure or descriptions of methods of materials which may be used. Nothing herein is to be construed as an admission that a publication or other reference (including any reference cited in the Background section) is prior art to the invention or that the invention is not entitled to antedate such disclosure, for example, by virtue of prior invention.

As used herein, the term “and/or”, e.g., “X and/or Y” shall be understood to mean either “X and Y” or “X or Y” and shall be taken to provide explicit support for both meanings or for either meaning, e.g. A and/or B includes the options i) A, ii) B or iii) A and B.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

The methods and compositions of the present disclosure may comprise, consist essentially of, or consist of the components and ingredients of the present disclosure as well as other ingredients described herein. As used herein, “consisting essentially of” means that the methods, systems, apparatuses and compositions may include additional steps, components or ingredients, but only if the additional steps, components or ingredients do not materially alter the basic and novel characteristics of the claimed methods, systems, apparatuses, and compositions.

Unless defined otherwise, all technical and scientific terms used above have the same meaning as commonly understood by one of ordinary skill in the art to which embodiments of the present disclosure pertain.

The terms “invention” or “present invention” are not intended to refer to any single embodiment of the particular invention but encompass all possible embodiments as described in the specification and the claims.

The term “about,” as used herein, refers to variation in the numerical quantity that can occur, for example, through typical measuring techniques and equipment, with respect to any quantifiable variable, including, but not limited to, concentration, mass, volume, time, molecular weight, temperatures, melting enthalpy, density, pH, humidity, molar ratios, log counts, and the like. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. Whether or not modified by the term “about,” the claims include equivalents to the quantities.

The term “actives” or “percent actives” or “percent by weight actives” or “actives concentration” are used interchangeably herein and refers to the concentration of those ingredients involved in cleaning expressed as a percentage minus inert ingredients such as water or salts. It is also sometimes indicated by a percentage in parentheses, for example, “chemical (10%).”

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups).

Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

As used herein, the term “analog” means a molecular derivative of a molecule. The term is synonymous with the terms “structural analog” or “chemical analog.”

As used herein, the term “between” is inclusive of any endpoints noted relative to a described range.

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

As used herein, the term “exemplary” refers to an example, an instance, or an illustration, and does not indicate a most preferred embodiment unless otherwise stated. The term “generally” encompasses both “about” and “substantially.”

As used herein the term “polymer” refers to a molecular complex comprised of a more than ten monomeric units and generally includes, but is not limited to, homopolymers, copolymers, such as for example, block, graft, random and alternating copolymers, terpolymers, and higher “x” mers, further including their analogs, derivatives, combinations, and blends thereof. Furthermore, unless otherwise specifically limited, the term “polymer” shall include all possible isomeric configurations of the molecule, including, but are not limited to isotactic, syndiotactic and random symmetries, and combinations thereof. Furthermore, unless otherwise specifically limited, the term “polymer” shall include all possible geometrical configurations of the molecule.

The term “Rayleigh Bernard Convection effect” or “Rayleigh Bernard effect” as referred to herein is a convection effect with a buoyance-driven flow in a container with a temperature gradient. The effect is seen as the fluid at the bottom heats up, its density decreases, so buoyant forces push the less-dense fluid up toward the cooler end of the container.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

The term “substantially” refers to a great or significant extent. “Substantially” can thus refer to a plurality, majority, and/or a supermajority of said quantifiable variable, given proper context.

The term “surfactant” or “surface active agent” refers to an organic chemical that when added to a liquid changes the properties of that liquid at a surface.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

### Stable Cast Solid Compositions

According to embodiments, stable cast solid compositions and methods of making the stable cast solid compositions are provided. These compositions and methods utilize a water scavenger, such as sodium sulfate to stabilize the molten cast solids during solidification. Without being limited to a particular mechanism of action, the water scavenger overcomes challenges associated with the various hydration states of materials, namely the granular materials, in the molten cast solutions. The compositions and methods described beneficially overcome any undesirable post-chilling cracking and other integrity issues in the cast solid composition.

### Caustic

The compositions and methods are suitable for use in a variety of types of cast solids employing granular raw materials. Cast compositions can employ molten solutions of concentrated caustic source (e.g. alkali metal hydroxide monohydrate and/or alkali metal alkoxide), preferably sodium hydroxide monohydrate (or molten caustic at higher temperatures).

Examples of concentrated caustic sources include an alkali metal hydroxide monohydrate (e.g. sodium hydroxide monohydrate), combinations of an alkali metal hydroxide monohydrate and alkali metal hydroxide dihydrate, and/or an alkali metal alkoxide. As referred to herein, caustic is synonymous to hydroxide. Any suitable source of caustic may be used. In an embodiment, an alkali metal caustic source may be used. For example, caustic sources may be in the form of sodium hydroxide, potassium hydroxide, lithium hydroxide, derivatives thereof, or and combinations thereof. An example of a derivative of a caustic source is a preformed alkoxide or an alkoxide generated in-situ.

In embodiments employing a concentrated caustic source the cast solid has an overall caustic to water weight ratio of 60:40 to 80:20. In embodiments employing an alkoxide as the concentrated caustic source the cast solid can have an overall caustic to water weight ratio less than about 70:30.

In certain embodiments an alkoxide can be used to form or in the concentrated caustic. In certain embodiments, an alkali metal hydroxide is reacted with an organic molecule having one or more hydroxyl-groups or an alkylene carbonate to form an alkoxide, as disclosed in U.S. patent application Ser. No. 18/606,681 titled “Alkoxide-Based Solidification Via Control of Reaction Equilibrium and Kinetics”, which is incorporated by reference in its entirety. As disclosed therein in certain embodiments a higher active caustic liquid is preferred for the control of equilibrium reaction and kinetics for the generation of an alkoxide. In an embodiment, the molar ratio of caustic to reagent (e.g. polyol such as propylene glycol) is about 1:1 to about 10:1 molar ratio, about 1:1 to about 8:1 molar ratio, about 1:1 to about 6:1 molar ratio, and preferably about 1:1.

In certain embodiments a concentrated caustic can be used in the methods of making an alkoxide and/or methods of making the molten sodium hydroxide monohydrate solution. In an embodiment, 70% NaOH is preferred over a 50% NaOH to provide the 1:1 (or greater) molar ratio of caustic to reagent. In preferred embodiments, a concentrated alkali metal hydroxide comprises greater than 50% (actives basis) liquid alkali metal hydroxide. In some embodiments, the concentrated alkali metal hydroxide is from about 69% to about 74% (actives basis) liquid alkali metal hydroxide, preferably from about 70% to about 73% (actives basis) liquid alkali metal hydroxide.

### Granular Raw Materials

Granular raw materials can vary across cast solid compositions. Cast solids with a higher concentration of the granular raw materials will benefit most from the use of the water scavenger and methods of making the cast solids described herein. In some embodiments, cast solid compositions comprise granular materials (including one or more different granular materials) in an amount of at least about 10 wt-%, 11 wt-%, 12 wt-%, 13 wt-%, 14 wt-%, 15 wt-%, 16 wt-%, 17 wt-%, 18 wt-%, 19 wt-%, 20 wt-%, 21 wt-%, 22 wt-%, 23 wt-%, 24 wt-%, 25 wt-%, or more in the cast solid.

A variety of granular materials can be employed in cast solid compositions. A commonly used granular raw material for cast solids is a chelant and/or threshold agent. In general, a chelating agent is a molecule capable of coordinating (i.e., binding) the metal ions commonly found in natural water to prevent the metal ions from interfering with the action of the other detersive ingredients of a cleaning composition. In an aspect, the chelant is an aminocarboxylic acid and/or salt, also referred to herein as an aminocarboxylate.

Beneficially, aminocarboxylates may include aminocarboxylic acids and/or salts of the aminocarboxylic acids. These are commonly used chelants as they do not contain phosphorus and/or contain little to no nitrilotriacetic acid (NTA). Exemplary aminocarboxylates (or acids thereof) include, but are not limited to: methylglycinediacetic acid (MGDA), glutamic acid-N,N-diacetic acid (GLDA), N-hydroxyethylaminodiacetic acid, ethylenediaminetetraacetic acid (EDTA), hydroxyethylenediaminetetraacetic acid, diethylenetriaminepentaacetic acid, N-hydroxyethyl-ethylenediaminetriacetic acid (HEDTA), diethylenetriaminepentaacetic acid (DTPA), ethylenediaminesuccinic acid (EDDS), 2-hydroxyethyliminodiacetic acid (HEIDA), iminodisuccinic acid (IDS), 3-hydroxy-2-2′-iminodisuccinic acid (HIDS) and other similar acids or salts thereof having an amino group with a carboxylic acid substituent. Additional description of suitable aminocarboxylates suitable for use as chelating agents and/or sequestrants is set forth in Kirk-Othmer, Encyclopedia of Chemical Technology, Third Edition, volume 5, pages 339-366 and volume 23, pages 319-320, the disclosure of which is incorporated by reference herein.

Additional granular raw materials used in cast solids are enzymes. It may be desirable to include enzymes in granular format to survive the harsh conditions of the cast solid processing. Examples of suitable enzymes include, but are not limited to, hemicellulases, peroxidases, proteases, cellulases, xylanases, lipases, phospholipases, esterases, cutinases, pectinases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, amylases, or combinations thereof and may be of any suitable origin. The choice of enzyme(s) takes into account factors such as pH-activity, stability optima, thermostability, stability versus active detergents, chelants, builders, etc.

Additional granular raw materials used in cast solids can include acids, such as for example carboxylic acids such as citric acid anhydrous, or sulfamic acid.

### Water Scavengers

Cast compositions employ a water scavenger comprising an alkali metal sulfate. In an embodiment the water scavenger comprises sodium sulfate, and preferably anhydrous sodium sulfate. Sodium sulfate, and anhydrous sodium sulfate are commercially available from various sources.

In some embodiments the water scavenger provides a single salt and does not combine multiple sats, such as potassium and sodium salts, which in some formulations are used to prevent premature solidification of solids. In such embodiments, which are not encompassed in the compositions and methods of the present invention, combinations of salts such as potassium and sodium hydroxide salts and amino carboxylate salts are used for solidification. Instead the compositions and methods of the present invention provide a water scavenger, preferably as a single salt, in an amount up to about 10 wt-% in a concentrated caustic source, preferably sodium hydroxide monohydrate as the molten solution and thereafter combining with a granular raw material during the cast processing to ensure non-cracked solids post chilling step of the production of the cast solid.

In embodiments the cast solid compositions comprise at least about 0.5 wt-%, or at least about 1 wt-% of the water scavenger preferably the anhydrous sodium sulfate, or at least about 2 wt-% of the water scavenger preferably the anhydrous sodium sulfate. In embodiments the cast solid compositions comprise between about 1 wt-% and about 10 wt-%, between about 2 wt-% and about 10 wt-%, or between about 2 wt-% and about 5 wt-% of the water scavenger. In addition, without being limited according to the disclosure, all ranges recited are inclusive of the numbers defining the range and include each integer within the defined range.

### Additional Components

Various other additional functional ingredients can be incorporated into the cast solid compositions and methods of making the same based on the particular application of use of the cast solid compositions. In some embodiments, the cast solid compositions including the concentrated caustic source, the granular raw materials, and the water scavenger provide for a stable cast solid and make up a large amount, or even substantially all of the total weight of the cast solid compositions. For example, in some embodiments few or no additional functional ingredients are disposed therein.

In other embodiments additional components can be incorporated into the cast solid compositions and methods of making the same. For example, the cast solid compositions can include a wetting agent such as an alkyl polyglycoside, a water conditioning polymer and/or chelant, a detersive surfactant, and/or a processing and/or solidification agent in addition to the concentrated caustic source, the granular raw materials, and the wetting agent. The processing and/or solidification agents can comprise a polyol, such as glycerin, and/or a wetting agent such as an alkyl polyglycoside.

In other embodiments, additional functional ingredients may be included in the cast solid compositions. The functional ingredients provide desired properties and functionalities to the compositions. For the purpose of this application, the term “functional ingredient” includes a material that when dispersed or dissolved in the molten cast solution and thereafter are incorporated into the cast solid provide a beneficial property in a particular use. In some embodiments, the cast solid compositions may include optical brighteners, defoaming agents, anti-redeposition agents, bleaching agents, solubility modifiers, dispersants, metal protecting agents, soil antiredeposition agents, stabilizing agents, corrosion inhibitors, builders/sequestrants/chelating agents, aesthetic enhancing agents including fragrances and/or dyes, additional rheology and/or solubility modifiers, hydrotropes or couplers, buffers, additional wetting agents, additional solidification and/or processing agents, additional cleaning agents and the like.

Additional description of suitable additional functional ingredients are included for example in U.S. application Ser. No. 18/605,977, which is incorporated by reference herein.

These additional ingredients can be included in the molten cast solution before or after the addition of the granular raw materials.

In some embodiments the composition as well as the additional functional ingredients do not include urea for the cast solids.

### Wetting Agent

Cast compositions can further employ a wetting agent to wet and then disperse or dissolve the granular raw materials in the cast solid molten solution of the concentrated sodium hydroxide monohydrate. The wetting agent ensures that the methods described herein product a stable cast solid composition where the granulate material is sufficiently dispersed or dissolved and therefore does not present formulation and/or processing limitations, such as cracking post chilling causing a lack of solid integrity of the cast solid composition. As referred to herein dispersion is a mixture of particles of one compound evenly dispersed throughout a continuous phase of another component.

Wetting agents can comprise a short chain linear or branched surfactant including an alkylpolyglycoside (APG) surfactant including alkylpolyglucoside surfactants, anionic surfactant and/or amphoteric surfactant. The short chain length provides hydrophobicity to wet the granular materials. In certain embodiments a branched structure is preferred to decrease foaming as well as enhance the wetting of the granular materials. As referred to herein short chain includes less than C10, from C2-C10, from C4-C10, from C6-C10, from C8-C10, from C2-C8, from C4-C8, from C6-C8, from C2-C6, from C4-C6, or any ranges therebetween.

Examples of commercially-available short chain APGs include for example from BASF Glucopon 215 UP (C8-C10 APG) and Glucopon 225 DK (C8-C10 APG), from Dow Triton BG-10 (C8-C10 APG), Triton CG-50 (C8-C10 APG), Triton CG-110 (C8-C10 APG), from Akzonobel AG 6202 (C8 APG), AG 6206 (C6 APG), as well as other commercial sources. In preferred embodiments the APG is a C6-C10 APG, a C6-C8 APG, an ethylhexyl alkylpolyglucoside, C6 alkylpolyglucoside or a C8 alkylpolyglucoside.

In embodiments the cast solid compositions comprise from about 0 wt-% to about 5 wt-% of the wetting agent. In preferred embodiment, the cast solid can include between about 1 wt-% to about 5 wt-% of the wetting agent and an additional surfactant, such as an APG and a nonionic surfactant such as Pluronic 25R2, an EO-PO surfactant.

In addition, without being limited according to the disclosure, all ranges recited are inclusive of the numbers defining the range and include each integer within the defined range.

According to embodiments, the following components to make the stable cast solid compositions: a concentrated caustic source, one or more granular raw materials, and a water scavenger comprising an alkali metal sulfate. In additional embodiments the stable cast solid compositions can include additional functional ingredients. Exemplary components used to make the stable cast solid compositions are shown in Table 1 and 2 in weight percentages. These component ranges to make the cast solid compositions result in the cast solids having the attributes as described herein, including a cast solid with an overall caustic to water weight ratio of 60:40 to 80:20, or a cast solid with an overall caustic to water weight ratio less than about 70:30.

While the components may have a percent actives of 100%, it is noted that Tables 1 and 2 do not recite the percent actives of the components, but rather, recites the total weight percentage of the raw materials (i.e. active concentration plus inert ingredients, such as water).

TABLE 1

| | First | Second | Third |
|---|---|---|---|
| | Exemplary | Exemplary | Exemplary |
| Material | Range wt.-% | Range wt.-% | Range wt.-% |
| Concentrated Caustic | 30-80 | 40-80 | 40-70 |
| Source | | | |
| Granular Raw | 10-30 | 10-25 | 10-25 |
| Materials | | | |
| Water Scavenger | 0.5-10 | 1-10 | 2-10 |
| Additional Functional | 0-40, or | 0-35, or | 0-30, or |
| Ingredients | 0.1-40 | 0.1-35 | 0.1-30 |
| Total | 100 | 100 | 100 |

TABLE 2

| | First | Second | Third |
|---|---|---|---|
| | Exemplary | Exemplary | Exemplary |
| Material | Range wt.-% | Range wt.-% | Range wt.-% |
| Concentrated Caustic | 30-80 | 40-80 | 40-70 |
| Source | | | |
| Granular Raw | 10-30 | 10-25 | 10-25 |
| Materials | | | |
| Water Scavenger | 0.5-10 | 1-10 | 2-10 |
| Wetting Agent | 0.5-10 | 1-10 | 1-5 |
| Additional Functional | 0-40, or | 0-35, or | 0-30, or |
| Ingredients | 0.1-40 | 0.1-35 | 0.1-30 |
| Total | 100 | 100 | 100 |

### Methods of Making Stable Cast Solids

Methods of making stable cast solid compositions include combining a molten concentrated sodium hydroxide monohydrate and a water scavenger to form a solution, and thereafter adding one or more granular raw materials to disperse within the solution. Without being limited to a particular mechanism of action the granular material is added to the molten solution last to avoid premature solidification within a mix tank for the cast solids. The methods utilize the water scavenger, such as sodium sulfate, to competitively bind to water in the molten cast solution and prevent various hydration states of the granular material to interference with the stability of the cast solid.

The methods include a first step of forming a gel phase with caustic sources, e.g. caustic beads added into a solution where there is an exothermic and thickening to form the gel phase. In embodiments the temperature commonly peaks around about 160° F.-200° F. and thereafter is maintained as a molten solution typically around about 140° F.-170° F.

The methods can further utilize a wetting agent in combination with the water scavenger, such as a low foaming wetting surfactant, to aid wetting and dispersion of the granular materials into the molten cast solution of the concentrated caustic source.

The use of the water scavenger has beneficially been found according to the methods described herein to overcome challenge in cast processing, namely the molten cast solution causing granular materials contained therein to hydrate and form various hydration states having distinct solidification matrices, that result in an instable cast solid or a cast solid that exhibits voids and/or cracking within the 24-hour chilling processing step. Without the inclusion of the water scavenger in the methods of making the cast solids various granular materials are unable to maintain in a stable state and instead would form hydrates leading to instability within the molten solution. As a result of the methods described herein, the granular materials are dispersed or dissolved within the molten solution and do not bind to water that is otherwise competitively scavenged by the water scavenger.

The result is that the compositions and the methods overcome any undesirable post-chilling cracking and other integrity issues in the cast solid composition. The compositions made according to the methods do not crack during the post chilling step. Moreover, the composition do not crack and maintain dimensional stability in all 8-week stability tests thereafter, providing for a stable cast solid composition suitable for storage and use thereafter.

The step of combining a water scavenger with the molten concentrated sodium hydroxide monohydrate to form a solution before adding the granular raw materials to disperse or dissolve therein provides processing benefits.

In further embodiments a wetting agent can also be added with the molten concentrated sodium hydroxide monohydrate to form a solution before adding the granular raw materials to disperse or dissolve therein to beneficially overcome disparities in density between the granular materials and the molten solution effectively preventing solid instability resulting from the Rayleigh Bernard Convection effect. This beneficially ensures that the granulate materials are dispersed or dissolved within the molten solution and do not salt-out from the molten solution, such as a caustic monohydrate matrix. In embodiments, this is the result of wetting a granular raw material having a lower density than the density of the molten solution to ensure dispersion or dissolution of the wetted granular raw material into the molten solution by increasing the density of the granular raw material closer to its true density (in non-granular form that more closely approximates the density of the molten solution).

The step of adding the water scavenger and/or the wetting agent to the molten sodium hydroxide monohydrate solution then involves mixing of the molten sodium hydroxide monohydrate solution until a relatively homogeneous mixture is formed. This can take a matter of minutes, such as about 10 minutes. The temperature of this this solution is between about 140° F.-170° F. for caustic cast solids (with higher peaks for these reaction temperatures possible). In embodiments where the cast solid composition employs acidic polymers in the composition, the only source of heating can be the exothermic reaction between the liquid caustic and acidic polymers. In other embodiments heat may be applied to the molten sodium hydroxide monohydrate solution.

The use of the water scavenger at the defined temperature ranges results in the molten solution solidifying. This is distinct from prior technical solutions to providing solidification that uses salts, such as potassium and sodium salts of alkalinity and amino carboxylates where the solidification requires the combination of salts. In the present compositions and methods, the inclusion of the granular material, such as a granular aminocarboxylate, as a last step prevents premature solidification of the molten solution.

The granular materials, such as the chelant, are added as the last step in the method of forming stable cast solid compositions. The granular material can be added over about 30 to about 60 minutes, while maintaining a constant temperature, such as about 140° F.-170° F.

The methods can further include adding additional functional ingredients into the composition. In an embodiment, the method further comprises adding to the solution one or more of water conditioning polymers, chelants, detersive surfactants, processing aids and/or solidification agents.

The methods of combining the materials within the molten solution are mixed within a vessel. The methods are often mixed using propeller blades or other mixing apparatus. Once the molten solution is mixed it is placed into a capsule having the desired shape and size of the cast solid.

The methods further include a chilling step to rapidly lower the temperature of the molten solution to solidify the composition after the molten solution is packed into capsules. The chiller step can include a chiller, such as a 0° F. chiller for about 45 minutes to about an hour. Once the capsules are removed from the chiller they will have a molten core with solidified edges. The capsules are thereafter cooled further at a temperature between about 70° F.-110° F. and during the next 24 hours the capsules are evaluated visually for any cracking.

The cast solids exhibit solid integrity and do not crack in the post-chilling step, including for the 24 hours post chilling of the molten solution. In further embodiments the solids further exhibit dimensional stability. In embodiments the cast solids further have a desirable dimensional stability. Dimensionally stability refers to a measurement of any change in dimension of a solid over a period of time under elevated temperature and humidity storage conditions as measured over an 8-week period to assess stability over longer period of time such as during transport and storage during which it is undesirable for a solid to swell or otherwise change dimensions over time. As referred to herein, a cast solid has a dimensional stability with less than about 3% change in any measured dimension when stored at a temperature of 50° C. and 70% relative humidity for a period of one month.

The cast solids prepared according to the methods described herein can be made into various shapes and sizes as one skilled in the art will ascertain from the disclosure here, which is practically limited by packaging and dispensing equipment. In an embodiment, a cast solid can have a per unit size of up to approximately 8 pounds, 9 pounds, 10 pounds, or larger.

### Methods of Use

The stable cast solid compositions are suitable for use in various water conditions to provide warewashing efficacy and benefits of providing a first pass clean to provide spotless ware, glasses and other treated surfaces, as well as providing a scale free machine in which the cast solids are used. These benefits provide significant operational efficiency, including reduction in labor due to eliminating the need to hand polish and treated ware or surfaces, as well as eliminating deliming steps.

However the stable cast solid compositions described herein can be used for methods of using various cleaning applications. These cleaning compositions can operate on an article, surface, or the like, by contacting it with a use solution of the cast solid composition described herein. Contacting can include any of numerous methods for applying a cleaning composition of the disclosure, such as spraying the compositions, immersing the article in compositions, circulating through a warewashing machine, or the like, or a combination thereof.

It should be understood that the concentration of the ingredients in the compositions will vary depending on whether the cleaning composition is provided as a concentrate or as a use solution. A use solution may be prepared from the concentrate by diluting the concentrate with water at a dilution ratio that provides a use solution having desired detersive properties.

Exemplary industries in which the present methods can be used include, but are not limited to: food service industry; food and beverage industry; the pharmaceutical manufacturing industry; laundry and textile care; and any other alkaline cleaning applications of use. Suitable uses for the compositions and methods may include, for example, bottle washing, machine warewashing, laundry and textile care, and the like.

The present methods can also be used to remove various types of soils. Such other soils include, but are not limited to, starch, cellulosic fiber, protein, simple carbohydrates and combinations of any of these soil types with mineral complexes.

In further embodiments, the methods of employing cleaning compositions are particularly suited for use in closed systems, e.g. dish or ware washing systems for cleaning, bottle washing systems and processes, sanitizing and/or disinfecting articles and surfaces.

The method includes contacting an article or surface with a cleaning composition or a cleaning use composition to wash the surface. The method can contact the liquid to any of a variety of surfaces or objects including surfaces or articles including those made of glass, ceramic, plastic, porcelain, aluminum, or the like.

The phrase “washing a surface with a wash solution (or a use solution or a cleaning composition)” refers to the circulation of a cleaning composition solution to remove substantially all soil from the treated surfaces (e.g. ware) and to keep that soil suspended or dissolved. In an embodiment, this step may be conducted where the temperature of the rinse water is up to about 140° F., preferably in the range of 100° F. to 140° F., preferably in the range of 110° F. to 140° F., and most preferably in the range of 120° F. to 140° F. As referred to herein, “low temperature” refers to those rinse water temperatures below about 140° F. For example, conventional rinse temperature for ware washing occurs above 140° F., such as from about 140° F. to about 190° F., particularly between about 145° F. to about 180° F. In an aspect, the methods employing a low temperature further employ a sanitizer.

Contacting can include any of numerous methods for applying a cleaning composition, such as spraying the composition, immersing the object in the composition, or a combination thereof. A concentrate or use concentration of a composition can be applied to or brought into contact with an article by any conventional method or apparatus for applying a cleaning composition to an object. For example, the object can be wiped with, sprayed with, and/or immersed in the composition, or a use solution made from the composition. The composition can be sprayed, or wiped onto a surface; the composition can be caused to flow over the surface, or the surface can be dipped into the composition. Contacting can be manual or by machine.

Before contacting an article or surface, a concentrate cleaning composition may be first diluted with water at the location of use to provide the use solution. When the composition is used in an automatic warewashing or dishwashing machine, it is expected that that the location of use will be inside the automatic warewashing machine. Depending on the machine, the composition may be provided in a unit dose form or in a multi-use form. In larger warewashing machines, a large quantity of composition may be provided in a compartment that allows for the release of a single dose amount of the composition for each wash cycle. Such a compartment may be provided as part of the warewashing machine or as a separate structure connected to the warewashing machine.

The cleaning composition may also be dispensed from a spray-type dispenser, such as that disclosed in U.S. Pat. Nos. 4,826,661, 4,690,305, 4,687,121, 4,426,362 and in U.S. Pat. Nos. Reissue 32,763 and 32,818, the disclosures of which are incorporated by reference herein. Briefly, a spray-type dispenser functions by impinging a water spray upon an exposed surface of the composition, and then immediately directing the use solution out of the dispenser to a storage reservoir or directly to a point of use. If necessary, in some embodiments, when used, the product may be removed from the packaging and inserted into the dispenser.

The methods may further employ one or more rinse steps for the treated articles or surfaces.

In some embodiments, the cleaning compositions include killing one or more of the pathogenic bacteria associated with health care surfaces and environments including, but not limited to, Salmonella typhimurium, Staphylococcus aureus, methicillin resistant Staphylococcus aureus, Salmonella choleraesurus, Pseudomonas aeruginosa, Escherichia coli, mycobacteria, yeast, and mold. The cleaning compositions have activity against a wide variety of microorganisms such as Gram positive (for example, Listeria monocytogenes or Staphylococcus aureus) and Gram negative (for example, Escherichia coli or Pseudomonas aeruginosa) bacteria, yeast, molds, bacterial spores, viruses, etc. The compositions as described above, have activity against a wide variety of human pathogens. The cleaning compositions can kill a wide variety of microorganisms on a food processing surface, on the surface of a food product, in water used for washing or processing of food product, on a health care surface, or in a health care environment.

The present methods can be used to achieve any suitable reduction of the microbial population in and/or on the target or the treated target composition. In some embodiments, the present methods can be used to reduce the microbial population in and/or on the target or the treated target composition by at least one log 10. In other embodiments, the present methods can be used to reduce the microbial population in and/or on the target or the treated target composition by at least two log 10. In still other embodiments, the present methods can be used to reduce the microbial population in and/or on the target or the treated target composition by at least three log 10. In still other embodiments, the present methods can be used to reduce the microbial population in and/or on the target or the treated target composition by at least five log 10. Without limiting the scope of disclosure, the numeric ranges are inclusive of the numbers defining the range and include each integer within the defined range.

The cleaning compositions can be used for a variety of domestic or industrial applications, e.g., to reduce microbial or viral populations on a surface or object or in a body or stream of water. The cleaning compositions can be applied in a variety of areas including kitchens, bathrooms, factories, hospitals, dental offices and food plants, and can be applied to a variety of hard or soft surfaces having smooth, irregular or porous topography. Suitable hard surfaces include, for example, architectural surfaces (e.g., floors, walls, windows, sinks, tables, counters and signs); eating utensils; hard-surface medical or surgical instruments and devices; and hard-surface packaging. Such hard surfaces can be made from a variety of materials including, for example, ceramic, metal, glass, wood or hard plastic. Suitable soft surfaces include, for example paper; filter media; hospital and surgical linens and garments; soft-surface medical or surgical instruments and devices; and soft-surface packaging. Such soft surfaces can be made from a variety of materials including, for example, paper, fiber, woven or nonwoven fabric, soft plastics and elastomers. The cleaning compositions can also be applied to soft surfaces such as food and skin (e.g., a hand). The present compounds can be employed as a non-foaming environmental sanitizer or disinfectant.

The cleaning compositions can be applied to microbes or to soiled or cleaned surfaces using a variety of methods. These methods can operate on an object, surface, in a body or stream of water or a gas, or the like, by contacting the object, surface, body, or stream with a compound of the disclosure. Contacting can include any of numerous methods for applying a compound, such as spraying the compound, immersing the object in the compound, foam or gel treating the object with the compound, or a combination thereof.

It is beneficial that the stable cast solid compositions provide both efficacious cleaning and performance compared to higher alkalinity/caustic-containing compositions. Moreover, these cast solids with higher granular raw materials content, such as chelants, and the lower alkalinity/caustic concentration in the cast solid can provide various labor, performance and asset protection benefits.

For example, with respect to labor savings the cast solids having ability to ‘drop in’ machines for use provide labor benefits that can be quantified based on the operational efficiency and efficacy of the compositions through soil (protein, fats/oils, spots/films, starch and coffee stains) removal. In addition, asset protection benefits can be quantified through observational benefits of improved machine health and substrate condition. The favorable performance and reduced labor results can include for example: reduced time required for scrubbing ware/plates/etc., reduced number of articles/substrates requiring rewashing and/or polishing resulting in efficiencies, machines with improved surfaces that result in decreased deliming frequency of cleaning and/or deliming which further provides safety and simplicity improvements. Still further the benefits can include preventing the labor, time and costs associated with removing scale in machines providing reduced energy costs and downtime of the machines for cleaning. For example, it can be estimated that each 1 mm of scale on a heating element corresponds to about a 7% increase in heating costs and results in reduction of parts lifetime of the machine itself. Accordingly, there are various benefits resulting from the stable cast solid compositions as described herein.

### EXAMPLES

Embodiments of the present disclosure are further defined in the following non-limiting Examples. It should be understood that these Examples, while indicating certain embodiments of the disclosure, are given by way of illustration only. From the above discussion and these Examples, one skilled in the art can ascertain the essential characteristics of this disclosure, and without departing from the spirit and scope thereof, can make various changes and modifications of the embodiments of the disclosure to adapt it to various usages and conditions. Thus, various modifications of the embodiments of the disclosure, in addition to those shown and described herein, will be apparent to those skilled in the art from the foregoing description. Such modifications are also intended to fall within the scope of the appended claims.

The following materials were utilized in the Examples:
AG6206: C6 alkylpolyglycoside available from Nouryon.
Acusol 445N: Fully neutralized acrylic acid homopolymer available from Dow.
Acusol 448: Acrylic/maleic copolymer having a molecular weight of 3,500 g/mol and available from Dow Chemical.
Acusol 929: Acrylic acid polymer having a molecular weight of 10,000 MW available from Dow Chemical.
Bayhibit AM/PBTC: 50% aq. solution of 2-Phosphonobutane-1,2,4-tricarboxylic acid available from Bayer Corp.
Caustic Bead: Solid Sodium Hydroxide Beads.
Dense Ash: alkalinity source.
GLDA: Glutamic acid-N,N-diacetic acid.
NaOH 50% Liquid (Liquid caustic): Sodium Hydroxide.
Pluronic N3: EO/PO copolymer with the general structure PO (20)-EO (23)-PO (20), or 30% EO by weight, available from BASF.
PSO: Phosphinosuccinic oligomer.
Trilon M Granule/MGDA: trisodium salt of methyl glycine diacetic acid, an aminocarboxylate available from BASF.
Sodium sulfate, anhydrous employed for testing.

### EMBODIMENTS

The present disclosure is further defined by the following numbered embodiments:

1. A cast solid composition comprising: a concentrated caustic source, preferably an alkali metal hydroxide monohydrate and/or an alkali metal alkoxide; b) one or more granular raw materials, and c) a water scavenger comprising an anhydrous alkali metal sulfate, wherein the composition is a cast solid and has an overall caustic to water weight ratio of 60/40 to 80/20, and the water scavenger aids in stabilizing the granular raw materials during the cast processing, resulting in non-cracked post chilling solid integrity.

1. A cast solid composition comprising: a concentrated caustic source comprising an alkali metal hydroxide monohydrate and/or an alkali metal alkoxide; b) one or more granular raw materials, and c) a water scavenger comprising an anhydrous alkali metal sulfate, wherein the composition is a cast solid and has an overall caustic to water weight ratio of 60/40 to 80/20, and the water scavenger aids in stabilizing the granular raw materials during the cast processing, resulting in non-cracked post chilling solid integrity.

2. The composition of paragraph 1, wherein the water scavenger is anhydrous sodium sulfate.

3. The composition of any one of paragraphs 1-2, wherein the composition comprises at least about 1 wt-% of the water scavenger.

4. The composition of any one of paragraphs 1-4, wherein the composition comprises at least about 2 wt-% of the water scavenger.

5. The composition of any one of paragraphs 1-4, wherein the granular raw material comprises at least about 10 wt-% of the cast solid, or at least about 15 wt-% of the cast solid.

6. The composition of any one of paragraphs 1-5, wherein the granular raw material comprises an aminocarboxylate.

7. The composition of paragraph 6, wherein the aminocarboxylate comprises methyl glycine diacetic acid (MGDA).

8. The composition of any one of paragraphs 1-7, further comprising a wetting agent, a water conditioning polymer and/or chelant, a detersive surfactant, and/or a processing and/or solidification agent.

9. The composition of paragraph 8, wherein the processing and/or solidification agent comprises a wetting agent and/or a polyol, preferably glycerin.

10. The composition of any one of paragraphs 1-9, wherein the composition is free of urea.

11. The composition of any one of paragraphs 1-10, wherein the concentrated caustic source is an alkali metal hydroxide monohydrate and/or an alkali metal alkoxide, and preferably sodium hydroxide.

12. A method of forming stable cast solid compositions comprising: combining a molten concentrated caustic source, preferably an alkali metal hydroxide monohydrate and/or an alkali metal alkoxide, and a water scavenger comprising an anhydrous alkali metal sulfate to form a solution; and thereafter adding one or more granular raw materials to disperse or dissolve within the solution, wherein the composition is a cast solid and has an overall caustic to water ratio of about 60/40 to about 80/20 if the caustic source is present and does not crack during post chilling of the cast solid.

13. The method of paragraph 12, wherein the method further comprises adding to the solution one or more of water conditioning polymers, chelants, detersive surfactants, processing aids and/or solidification agents.

14. The method of any one of paragraphs 12-13, further comprising adding a wetting agent to the molten concentrated sodium hydroxide monohydrate to form a solution before adding the granular raw materials to aid in dispersing or dissolving the granular raw materials within the solution.

15. The method of paragraph 14, wherein the wetting agent is a processing aid comprising an alkyl polyglycoside.

16. The method of any one of paragraphs 12-15, wherein the cast solid has a solid integrity as measured by lack of cracking in the solid for at least 24 hours post chilling of the cast solid.

17. The method of any one of paragraphs 12-16, wherein the one or more granular raw materials is the last material added in the method of forming the stable cast solid compositions.

18. The method of any one of paragraphs 12-17, wherein the one or more granular raw materials are added to the molten solution and mixed for at least about 30 minutes.

19. The method of any one of paragraphs 12-18, wherein the water scavenger is anhydrous sodium sulfate.

20. The method of any one of paragraphs 12-18, wherein the composition comprises at least about 1 wt-% of the water scavenger, or preferably at least about 2 wt-% of the water scavenger.

21. The method of any one of paragraphs 12-20, wherein the granular raw material comprises at least about 10 wt-% of the cast solid, or at least about 15 wt-% of the cast solid.

22. The method of any one of paragraphs 12-21, wherein the granular raw material comprises an aminocarboxylate.

23. A method of use comprising: generating a use solution of the cast solid composition according to any one of paragraphs 1-11; and contacting an article or surface in need of cleaning.

### Example 1

Cast solids were prepared from the formulas of Table 3 and evaluated for 24 hours post chilling for voids. The formulas were mixed for 15 minutes after Caustic Bead addition and another 15 minutes after Trilon M Granule (MGDA granulate) addition. The procedure for making the cast solids included the following methodology:

First NaOH was added to mixing vessel and then mixed. Then water, GLDA, Bayhibit, and polymer were added and mixed for about 5 minutes. The temperature was kept below about 150° F. to avoid cooling once caustic bead was added; thereafter the temperature was maintained between about 145° F. and 170° F. Then caustic bead was added, and temperature monitored to avoid temperature drop while mixing for at least about 15 minutes. The remaining materials were added. The granulate material, Trilon M, was added last to the mix tank. Cooling could be added if needed to bring temperature below about 160° F. The capsules were then packed out into capsules and chilled.

TABLE 3

| Component | AS0 | AS2 | AS4 | AS6 | A3-2 | F11 | F11-G1 | G11-G2 | G11-G3 |
|---|---|---|---|---|---|---|---|---|---|
| NaOH 50% | 18.0% | 18.0% | 18.0% | 18.0% | 18.0% | 18.0% | 18.0% | 18.0% | 18.0% |
| Liquid | | | | | | | | | |
| Water | 2.0% | 2.0% | 2.0% | 2.0% | 0.0% | 4.0% | 4.0% | 4.0% | 4.0% |
| GLDA | 3.0% | 3.0% | 3.0% | 3.0% | 3.0% | 3.0% | 3.0% | 3.0% | 3.0% |
| Bayhibit AM | 3.0% | 3.0% | 3.0% | 3.0% | 3.0% | 3.0% | 3.0% | 3.0% | 3.0% |
| Acusol 448 | 8.0% | 8.0% | 8.0% | 8.0% | 8.0% | 5.0% | 5.0% | 5.0% | 5.0% |
| PSO | 2.5% | 2.5% | 2.5% | 2.5% | 5.0% | 3.0% | 3.0% | 3.0% | 3.0% |
| Acusol 445N | 0.0% | 0.0% | 0.0% | 0.0% | 0.0% | 0.0% | 0.0% | 0.0% | 0.0% |
| Acusol 929 | 0.0% | 0.0% | 0.0% | 0.0% | 0.0% | 1.0% | 1.0% | 1.0% | 1.0% |
| Caustic Bead | 44.0% | 44.0% | 44.0% | 44.0% | 44.0% | 44.0% | 44.0% | 44.0% | 44.0% |
| Dense Ash | 0.0% | 2.0% | 4.0% | 6.0% | 0.0% | 0.0% | 0.0% | 0.0% | 0.0% |
| Sodium | 0.0% | 0.0% | 0.0% | 0.0% | 0.0% | 0.0% | 2.0% | 4.0% | 7.5% |
| Gluconate | | | | | | | | | |
| Sodium | 0.0% | 0.0% | 0.0% | 0.0% | 0.0% | 0.0% | 0.0% | 0.0% | 0.0% |
| Sulfate | | | | | | | | | |
| Pluronic N3 | 1.0% | 1.0% | 1.0% | 1.0% | 1.0% | 1.0% | 1.0% | 1.0% | 1.0% |
| or Pluronic | | | | | | | | | |
| 25R2 | | | | | | | | | |
| Hexylene | 0.1% | 0.1% | 0.1% | 0.1% | 0.0% | 0.1% | 0.1% | 0.1% | 0.1% |
| Glycol | | | | | | | | | |
| Trilon M | 18.0% | 18.0% | 18.0% | 18.0% | 18.0% | 18.0% | 18.0% | 18.0% | 18.0% |
| Granule | | | | | | | | | |
| (MGDA) | | | | | | | | | |
| Total | 99.6 | 101.6 | 103.6 | 105.6 | 100 | 100.1 | 102.1 | 104.1 | 107.6 |

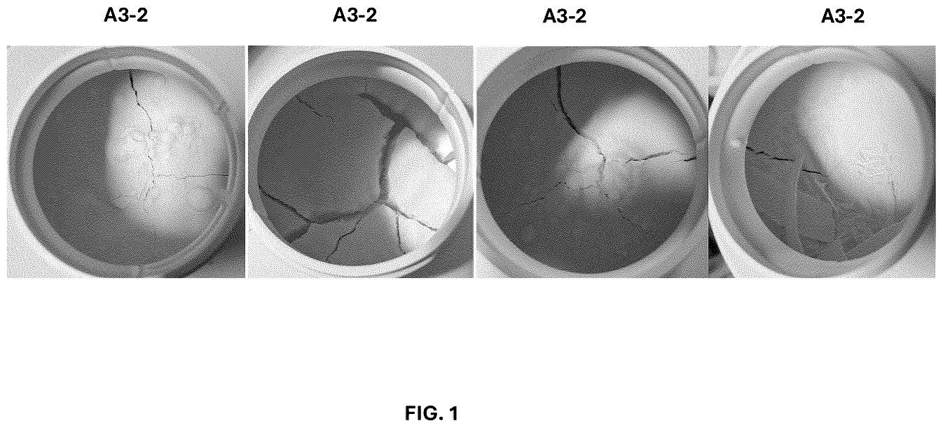

The control formulations ASO and F11 that did not include any water scavenger materials (i.e. alkali metal sulfate) present, exhibited voids. FIG. 1 shows a batch of formula A3-2 with no Sulfate after 48 hours of time. The product's appearance was described as: lots of bubbles, large cracks, and voids in capsule. The capsule appeared crushed.

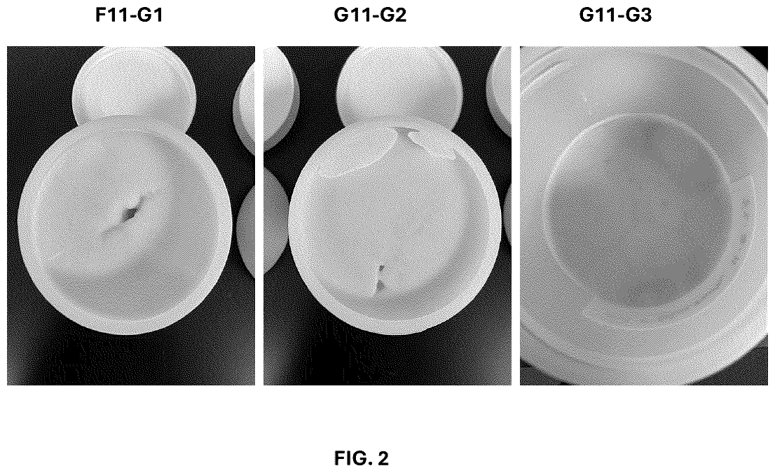

After 24 hours, formula AS2 (2% Dense Ash) did not have voids/cracks, while formulas AS4 and AS6 (4% and 6% Dense Ash respectively) both had voids/cracks. Formulas F11-G1, G11-G2, and G11-G3 containing 2-7.5% sodium gluconate all had small voids, indicating the cast solid product will crack and had small cell-like convection structures throughout, which were most visible on formula G11-G3 which had 7.5% Sodium Gluconate as shown in FIG. 2.

### Example 2

The formulas of Table 4 were tested for voids/cracking using the methodology of Example 1 with the addition of the competitive water scavenger sodium sulfate.

TABLE 4

| Component | H5 | H10 | H11 | H12 | H13 | H16 | F14 |
|---|---|---|---|---|---|---|---|
| NaOH 50% | 18.3% | 18.0% | 18.0% | 18.0% | 18.0% | 18.3% | 18.0% |
| Liquid | | | | | | | |
| Water | 0.0% | 2.0% | 2.0% | 2.0% | 2.0% | 0.0% | 4.0% |
| GLDA | 3.0% | 3.0% | 3.0% | 3.0% | 3.0% | 3.0% | 3.0% |
| Bayhibit | 3.0% | 3.0% | 3.0% | 3.0% | 3.0% | 3.0% | 3.0% |
| AM | | | | | | | |
| Acusol 448 | 7.0% | 8.0% | 8.0% | 8.0% | 8.0% | 7.0% | 6.0% |
| PSO | 0.0% | 2.5% | 2.5% | 2.5% | 2.5% | 0.0% | 2.0% |
| Acusol | 5.0% | 0.0% | 0.0% | 0.0% | 0.0% | 2.0% | 0.0% |
| 445N | | | | | | | |
| Acusol 929 | 0.0% | 0.0% | 0.0% | 0.0% | 0.0% | 0.0% | 0.0% |
| Caustic | 43.6% | 44.0% | 44.0% | 44.0% | 44.0% | 43.6% | 44% |
| Bead | | | | | | | |
| Dense Ash | 0.0% | 0.0% | 0.0% | 0.0% | 0.0% | 0.0% | 0.0% |
| Sodium | 0.0% | 0.0% | 0.0% | 0.0% | 0.0% | 0.0% | 0.0% |
| Gluconate | | | | | | | |
| Sodium | 1.0% | 1.0% | 1.9% | 5.0% | 7.0% | 1.0% | 1.0% |
| Sulfate | | | | | | | |
| Pluronic N3 | 1.0% | 1.0% | 1.0% | 1.0% | 1.0% | 1.0% | 1.0% |
| Hexylene | 0.1% | 0.1% | 0.1% | 0.1% | 0.1% | 0.1% | 0.1% |
| Glycol | | | | | | | |
| Trilon M | 18.0% | 18.0% | 18.0% | 18.0% | 18.0% | 18.0% | 18.0% |
| Granule | | | | | | | |
| (MGDA) | | | | | | | |
| Total | 100.0% | 100.6% | 101.5% | 104.6% | 106.6% | 97.0% | 100.1% |
| Voids | No | No | No | No | No | No | Deep |
| | Voids | Voids | Voids | Voids | Voids | Voids | Voids |
| | and no | | | | | | |
| | cracking | | | | | | |
| Density | 1.568 | 1.478 | 1.559 | 1.494 | 1.520 | — | — |
| Viscosity | 3,896 | 1,864 | 2,688 | 1,864 | 1,624 | — | — |

Formula H5 showed great results with no cracking or swelling after 24 hours. It was observed that the addition of MGDA at the end of the batch was important as adding midway through resulted in too low viscosity which resulted in separation or deep cracks forming. H5 solidified quickly and had a great appearance however the gel phase was thick and the MGDA did not appear to fully dissolve and still had many large particles after 15 minutes of mixing. The formula was 150° F. before Caustic Bead addition which decreased to 140° F. after the addition of Caustic Bead and later increased to 155° F. following the addition of MGDA.

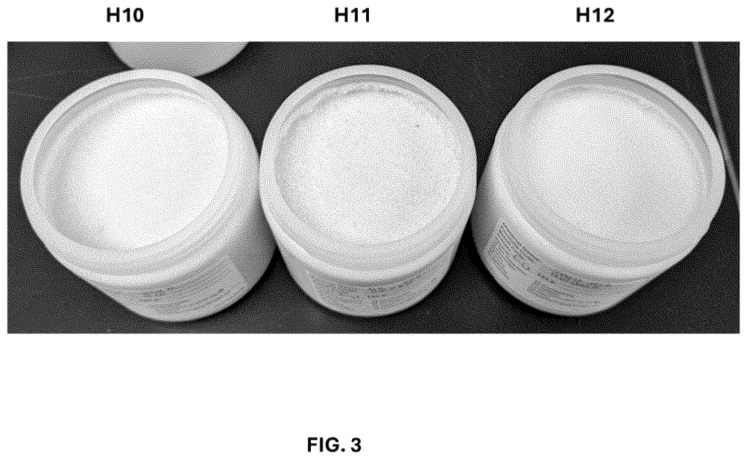

Formulas H10, H11, and H12 included extra Water, PSO, and Sodium Sulfate, none of which were observed to have voids or cracks as shown in FIG. 3. During processing, H10 had almost no gel phase but had some crusting with the foam on the top surface. During processing, H11 had almost no gel phase and cooled quickly, however a crust formed on the surface. During processing, H12 had some foam, with a good gel phase, and the temperature stayed under 190° F., however the MGDA floated to the top after pouring into capsules.

Formula H13 included extra Water and 7% Sodium Sulfate and cracked after 20 minutes while cooling. During processing, formula H13 had a crust on top but an easy gel phase. After 24 hours, formula H13 was observed to have cracks and a void in the middle.

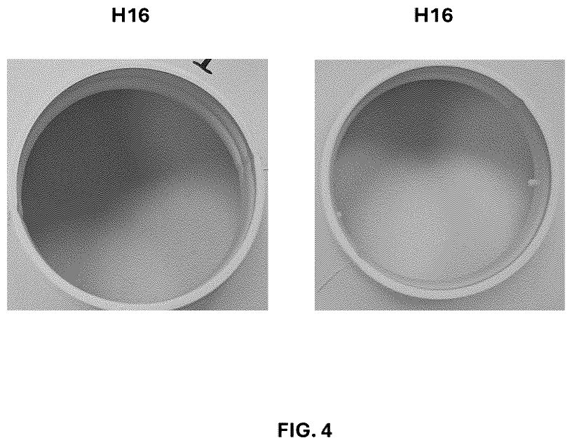

Formula H16 is similar to formulas H10, H11, and H12 but without added water and with Acusol 445N instead of PSO because Acusol 445N has higher viscosity. During processing, a really thick gel phase was observed, however formula H16 showed no cracks or voids as shown in FIG. 4.

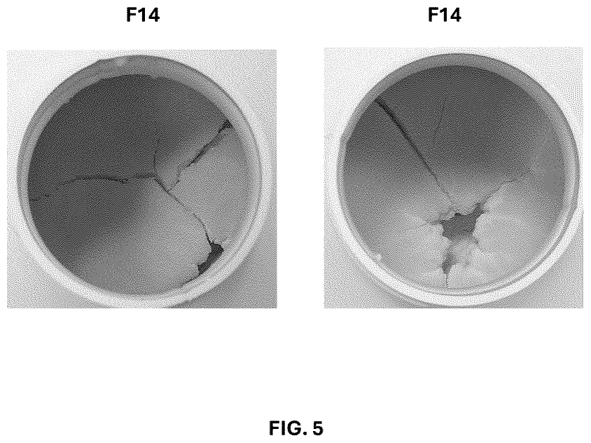

Formula F14 displayed deep cracks after 24 hours as shown in FIG. 5, suggesting a formula with 1.0% Sodium Sulfate can tolerate 3.0% excess Water, but not 4.0%.

### Example 3

Testing of formula 2-1 formula shown in Table 5 with and without water contamination to assess robustness of the compositions was completed.

TABLE 5

| Component | 2-1 | 2-14 |
|---|---|---|
| NaOH 50% Liquid | 18.30% | 18.30% |
| Free Water/Water | 0.00% | 3.00% |
| Contamination | | |
| GLDA | 3.00% | 3.00% |
| Bayhibit AM | 3.00% | 3.00% |
| Acusol 448 | 7.00% | 7.00% |
| Acusol 445N | 2.00% | 2.00% |
| AG6206 | 1.00% | 0.00% |
| Caustic Bead | 44.00% | 44.00% |
| Sodium Sulfate | 4.00% | 4.00% |
| Pluronic N3 | 1.00% | 1.00% |
| Hexylene Glycol | 0.10% | 0.10% |
| Trilon M Granule | 18.00% | 18.00% |
| (MGDA) | | |
| Total | 101.40% | 103.40% |
| Voids | No Voids | No Voids |
| | and no | and no |
| | cracking | cracking |
| Density | 1.42 | 1.42 |
| Viscosity | 4,560 | 4,560 |

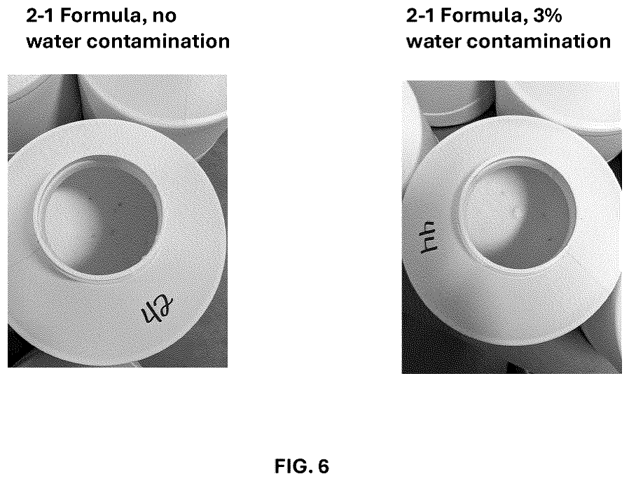

Both formula batches, with and without water contamination, were packed out and chilled for 45 minutes at 0° F., followed by 24 hours in a 104° F. chamber. Neither batch showed cracking, however some small craters and amber chunks were observed as shown in FIG. 6. Both formulas showed stable cast solids with no cracking. These results show the role of Sodium Sulfate to prevent cracking with various amounts of water contamination. Formula 2-1 with and without 3% water contamination demonstrates that Sodium Sulfate can prevent cracking even with excess water added to the formula. However, Formula 2-14 contains 4% water contamination and experienced cracking, demonstrating the evaluated 1% sodium sulfate in the formula was able to compensate for up to 3% additional water in the cast solids.

It is to be understood that while the invention has been described in conjunction with the detailed description thereof, the foregoing description is intended to illustrate, and not limit the scope of the invention, which is defined by the scope of the appended claims. Other embodiments, advantages, and modifications are within the scope of the following claims. Any reference to accompanying drawings which form a part hereof, are shown, by way of illustration only. It is understood that other embodiments may be utilized, and structural changes may be made without departing from the scope of the present disclosure.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

What is claimed is:

1. A cast solid composition comprising:
a) a concentrated caustic source comprising an alkali metal hydroxide monohydrate and/or an alkali metal alkoxide;
b) one or more granular raw materials, and
c) a water scavenger comprising an anhydrous alkali metal sulfate,
wherein the composition is a cast solid and has an overall caustic to water weight ratio of 60/40 to 80/20, and the water scavenger aids in stabilizing the granular raw materials during the cast processing, resulting in non-cracked post chilling solid integrity.

2. The composition of claim 1, wherein the water scavenger is anhydrous sodium sulfate.

3. The composition of claim 1, wherein the composition comprises at least about 1 wt-% of the water scavenger, or at least about 2 wt-% of the water scavenger.

4. The composition of claim 1, wherein the granular raw material comprises at least about 10 wt-% of the cast solid, or at least about 15 wt-% of the cast solid.

5. The composition of claim 1, wherein the granular raw material comprises an aminocarboxylate.

6. The composition of claim 5, wherein the aminocarboxylate comprises methyl glycine diacetic acid (MGDA).

7. The composition of claim 1, further comprising a water conditioning polymer and/or chelant, a detersive surfactant, and/or a processing and/or solidification agent.

8. The composition of claim 1, wherein the composition is free of urea.

9. The composition of claim 1, wherein the concentrated caustic source is an alkali metal hydroxide monohydrate and/or an alkali metal alkoxide.

10. A method of forming stable cast solid compositions comprising:
combining a molten concentrated caustic source comprising an alkali metal hydroxide monohydrate and/or an alkali metal alkoxide and a water scavenger comprising an anhydrous alkali metal sulfate to form a solution; and
thereafter adding one or more granular raw materials to disperse or dissolve within the solution,
wherein the composition is a cast solid and has an overall caustic to water ratio of about 60/40 to about 80/20 if the caustic source is present and does not crack during post chilling of the cast solid.

11. The method of claim 10, wherein the method further comprises adding to the solution one or more of water conditioning polymers, chelants, detersive surfactants, processing aids and/or solidification agents.

12. The method of claim 11, wherein the processing aid comprises an alkyl polyglycoside.

13. The method of claim 10, wherein the cast solid has a solid integrity as measured by lack of cracking in the solid for at least 24 hours post chilling of the cast solid.

14. The method of claim 10, wherein the one or more granular raw materials is the last material added in the method of forming the stable cast solid compositions.

15. The method of claim 10, wherein the one or more granular raw materials are added to the molten solution and mixed for at least about 30 minutes.

16. The method of claim 10, wherein the water scavenger is anhydrous sodium sulfate.

17. The method of claim 10, wherein the composition comprises at least about 1 wt-% of the water scavenger, or at least about 2 wt-% of the water scavenger.

18. The method of claim 10, wherein the granular raw material comprises at least about 10 wt-% of the cast solid, or at least about 15 wt-% of the cast solid.

19. The method of claim 10, wherein the granular raw material comprises an aminocarboxylate.

20. A method of use comprising:
generating a use solution of the cast solid composition according to claim 10; and
contacting an article or surface in need of cleaning.
